(19) United States
(12) Patent Application Publication
(10) Pub. No.: US 2015/0263338 A1
(43) Pub. Date: Sep. 17, 2015

(54) CATHODE MATERIAL

(71) Applicant: HONDA MOTOR CO., LTD., Tokyo (JP)

(72) Inventors: Akihiro Yoshizawa, Saitama (JP); Yuji Isogai, Saitama (JP); Shintaro Aoyagi, Saitama (JP)

(21) Appl. No.: 14/639,565

(22) Filed: Mar. 5, 2015

(30) Foreign Application Priority Data
Mar. 13, 2014 (JP) 2014-050107

(51) Int. Cl. H01M 4/36; H01M 4/58; H01M 4/485; H01M 4/62

(52) U.S. Cl. CPC H01M 4/364; H01M 4/625; H01M 4/582; H01M 4/485; H01M 4/5825

(57) ABSTRACT

There is provided a cathode material capable of reducing the overvoltage in the charge and discharge time and attaining an excellent energy efficiency when the cathode material is used for a cathode of a non-aqueous electrolyte secondary battery. The cathode material is used for a cathode of a secondary battery comprising a non-aqueous electrolyte, and contains FeF₃ and Li₄Ti₅O₁₂ as cathode active materials.

### BACKGROUND OF THE INVENTION

1. Field of the Invention

The present invention relates to a cathode material to be used in a secondary battery (hereinafter, abbreviated to a non-aqueous electrolyte secondary battery in some cases) comprising a non-aqueous electrolyte.

2. Description of the Related Art

As a cathode active material of chargeable-and-dischargeable non-aqueous electrolyte secondary batteries to be used for driving power sources of electric vehicles, for example, use of a metal fluoride represented by the general formula MF₃ is known (see Japanese Patent Laid-Open No. 2008-130265). In the above general formula MF₃, M is one metal element selected from the group consisting of Fe, V, Ti, Co and Mn.

A metal fluoride represented by the above general formula MF₃ has a high theoretical energy density (reversible capacity), and for example, a non-aqueous electrolyte secondary battery using FeF₃ as its cathode active material and Li as its anode active material is said to have a theoretical energy density of about 240 mAh/g.

However, if a non-aqueous electrolyte secondary battery is constituted by using, for its cathode, a cathode material whose cathode active material is composed only of FeF₃, there arises such trouble that the overvoltage at the time of charge and discharge becomes high.

There are the following three cases where the overvoltage in the charge and discharge time becomes high. The first one is a case where the average charge potential is high; the second one is a case where the average discharge potential is low; and the third one is a case where the average charge potential is high and the average discharge potential is low.

In a non-aqueous electrolyte secondary battery, the energy efficiency is represented by the following expression. Therefore, if the overvoltage in the charge and discharge time becomes high, a sufficient energy efficiency cannot be attained.

An energy efficiency (%)={an electric energy (output)/an electric energy (input)}×100={(an average discharge potential×a discharge capacity)/(an average charge potential×a charge capacity)}×100

### SUMMARY OF THE INVENTION

In order to solve the above-mentioned problem, it is an object of the present invention to provide a cathode material capable of reducing the overvoltage at the time of charge and discharge and attaining an excellent energy efficiency when the cathode material is used for a cathode of a non-aqueous electrolyte secondary battery.

In order to achieve the above object, the present invention provides a cathode material to be used for a cathode of a secondary battery containing a non-aqueous electrolyte, wherein the cathode material comprises FeF₃ and Li₄Ti₅O₁₂ as its cathode active materials.

Since the cathode material according to the present invention contains, in addition to FeF₃, Li₄Ti₅O₁₂ as a cathode active material, as compared with the case where the cathode active material is composed only of FeF₃, Li ions are easily released in the charge time and the average charge potential can be reduced. Therefore, use of the cathode material according to the present invention, as the cathode of a secondary battery comprising a non-aqueous electrolyte, can reduce the overvoltage at the time of charge and discharge, and can attain an excellent energy efficiency.

In the cathode material according to the present invention, FeF₃ and Li₄Ti₅O₁₂ as the cathode active materials are, in mass ratio, preferably in the range of FeF₃:Li₄Ti₅O₁₂=50:50 to 90:10. When the mass ratio of FeF₃ and Li₄Ti₅O₁₂ is less than FeF₃:Li₄Ti₅O₁₂=50:50, the content of FeF₃ in the cathode material is relatively low and a sufficient energy density cannot be attained in some cases. In contrast, when the mass ratio of FeF₃ and Li₄Ti₅O₁₂ exceeds FeF₃:Li₄Ti₅O₁₂=90:10, the content of Li₄Ti₅O₁₂ in the cathode material is relatively low and the effect of reducing the overvoltage in the charge and discharge time cannot sufficiently be attained in some cases.

The cathode material according to the present invention preferably further comprises a conductive auxiliary. The cathode material according to the present invention can facilitate transfer of electric charges by containing a conductive auxiliary.

Further in the cathode material according to the present invention in the case of containing the conductive auxiliary, the mass ratio of the cathode active material and the conductive auxiliary is preferably in the range of the cathode active material:the conductive auxiliary=50:50 to 90:10. When the mass ratio of the cathode active material and the conductive auxiliary is less than the cathode active material:the conductive auxiliary=50:50, the content of the cathode active material in the cathode material is relatively low and a sufficient energy density cannot be attained in some cases. In contrast, when the mass ratio of the cathode active material and the conductive auxiliary exceeds the cathode active material:the conductive auxiliary=90:10, the content of the conductive auxiliary in the cathode material is relatively low and the effect of facilitating transfer of electric charges cannot sufficiently be attained in some cases.

The cathode material according to the present invention preferably further comprises LiFePO₄ as the cathode active material. The incorporation of LiFePO₄, in addition to FeF₃ and Li₄Ti₅O₁₂, as the cathode active material in the cathode material according to the present invention, when the cathode material is used for a cathode of a secondary battery comprising non-aqueous electrolyte, not only can reduce the average charge potential but also can raise the average discharge potential. Therefore, use of the cathode material according to the present invention comprising LiFePO₄ as the cathode active material, in a cathode of a secondary battery containing non-aqueous electrolyte, can further reduce the overvoltage in the charge and discharge time, and further can attain an excellent energy efficiency.

### BRIEF DESCRIPTION OF THE DRAWINGS

FIG. 1 is a graph showing a relationship between the charge and discharge capacities and the battery voltage of a non-aqueous electrolyte secondary battery using, for its cathode, a cathode material according to a first aspect of the present invention; and

FIG. 2 is a graph showing a relationship between the charge and discharge capacities and the battery voltage of a non-aqueous electrolyte secondary battery using, for its cathode, a cathode material according to a second aspect of the present invention.

### DETAILED DESCRIPTION OF THE PREFERRED EMBODIMENTS

Next, embodiments according to the present invention will be described in more detail by reference to the accompanying drawings.

A cathode material (positive electrode material) of a first aspect of the present embodiment comprises FeF₃ and Li₄Ti₅O₁₂ as its cathode active materials in a mass ratio in the range of FeF₃:Li₄Ti₅O₁₂=50:50 to 90:10.

Further the cathode material of the first aspect comprises the cathode active material and a conductive auxiliary in a mass ratio in the range of the cathode active material:the conductive auxiliary=50:50 to 90:10. As the conductive auxiliary, there can be used a carbonaceous material such as Ketjen black, carbon black, carbon fibers or carbon nanotubes. The carbonaceous material may be used singly or as a mixture of two Or more.

The cathode material of the first aspect can be produced as follows.

First, an FeF₃ powder and a Li₄Ti₅O₁₂ powder are weighed so as to be in a mass ratio in the above range, mixed and pulverized by a pulverizing apparatus such as a planetary ball mill or the like to thereby obtain a mixed powder of a cathode active material. Then, the mixed powder of the cathode active material and the conductive auxiliary are weighed so as to be in a mass ratio in the above range, mixed and pulverized by a pulverizing apparatus such as a planetary ball mill to thereby obtain a mixed powder of a cathode material.

The mixed powder of the cathode material is kneaded with a binder, and the obtained kneaded material is pressed onto a current collector to thereby form a cathode (positive electrode). As the binder, for example, a polytetrafluoroethylene or the like can be used. As the current collector, for example, an aluminum mesh can be used.

Then, a cathode material of a second aspect of the present embodiment is all the same as the cathode material of the first aspect, except for comprising LiFePO₄ as its cathode active material in addition to FeF₃ and Li₄Ti₅O₁₂. In this case, the cathode material of the second aspect can contain LiFePO₄, with respect to the total amount of FeF₃ and Li₄Ti₅O₁₂, in a mass ratio in the range of (FeF₃+Li₄Ti₅O₁₂):LiFePO₄=50:50 to 90:10.

The cathode material of the second aspect can be produced just as in the cathode material of the first aspect, except for obtaining a mixed powder of a cathode active material by weighing and mixing an FeF₃ powder, a Li₄Ti₅O₁₂ powder and LiFePO₄ so as to be in a mass ratio in the above range, and pulverizing the mixture by a pulverizing apparatus such as a planetary ball mill or the like.

Further a cathode can be formed just as in the cathode of the first aspect, except for using a mixed powder of a cathode material containing FeF₃, Li₄Ti₅O₁₂ and LiFePO₄ for the cathode material of the second aspect.

Next, Examples according to the present invention and Comparative Example will be shown.

### EXAMPLE 1

In the present Example, first, 0.5 g of an FeF₃ powder (manufactured by Sigma-Aldrich Corp.) and 0.5 g of a Li₄Ti₅O₁₂ powder (manufactured by Sigma-Aldrich Corp.) were mixed, and the obtained mixture was pulverized by a planetary ball mill to thereby obtain a mixed powder of a cathode active material.

Then, 0.3 g of the mixed powder of the cathode active material obtained in the present Example and 0.3 g of Ketjen black (manufactured by Lion Corp., trade name: Carbon ECP) as a conductive auxiliary were mixed, and the obtained mixture was pulverized by a planetary ball mill to thereby obtain a mixed powder of a cathode material.

Then, 27 mg of the mixed powder of the cathode material obtained in the present Example and 3 mg of a polytetrafluoroethylene as a binder were kneaded in a mortar to thereby obtain a kneaded material. Then, the obtained kneaded material was pressed onto a current collector composed of an aluminum mesh by using a uniaxial press, and dried under vacuum to thereby form a cathode. Then, a Li foil was applied on a current collector prepared by welding an SUS mesh on an SUS plate to thereby form an anode (negative electrode).

Then, the cathode and the anode were laminated through a separator composed of a polypropylene microporous film Then, the separator was impregnated with a non-aqueous electrolyte solution to thereby form a coin-type non-aqueous electrolyte secondary battery. As the non-aqueous electrolyte solution, a solution was used in which LiPF₆ as a supporting salt was dissolved in a mixed solvent of ethylene carbonate and diethyl carbonate.

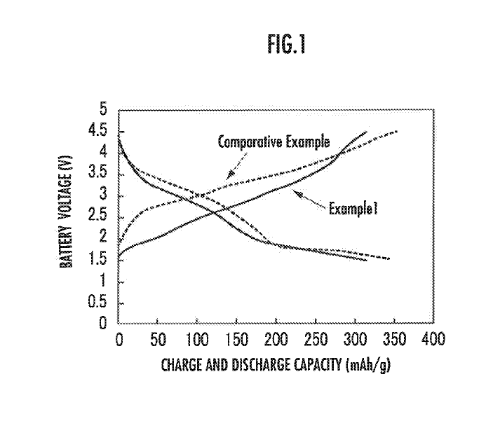

Then, the charge and discharge characteristics of the coin-type non-aqueous electrolyte secondary battery obtained in the present Example were measured. The measurement was carried out in the air at room temperature (25° C.) and at potentials in the range of 1.5 to 4.5 V with respect to Li and at a current of 0.1 mA to thereby acquire charge and discharge curves. The acquired charge and discharge curves are shown in FIG. 1.

Then, from the acquired charge and discharge curves, the average charge potential, the charge capacity, the average discharge potential and the discharge capacity were determined, and the overvoltage in the charge and discharge time and the energy efficiency were calculated by the following expressions.

An overvoltage in the charge and discharge time (V)=an average charge potential−an average discharge potential

An energy efficiency (%)={(the average discharge potential×a discharge capacity)/(the average charge potential×a charge capacity)}×100

The calculated overvoltage in the charge and discharge time and energy efficiency are shown in Table 1.

### Comparative Example

In the present Comparative Example, first, 0.5 g of an FeF₃ powder (manufactured by Sigma-Aldrich Corp.) and 0.5 g of Ketjen black (manufactured by Lion Corp., trade name: Carbon ECP) as a conductive auxiliary were mixed, and the obtained mixture was pulverized by a planetary ball mill to thereby obtain a mixed powder of a cathode material.

Then, a coin-type non-aqueous electrolyte secondary battery was formed just as in Example 1, except for using the mixed powder of the cathode material obtained in the present Comparative Example.

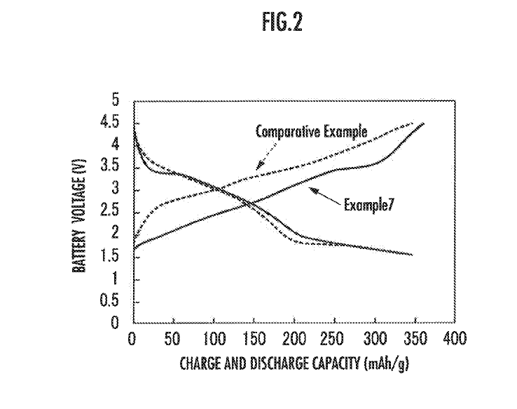

Then, the charge and discharge characteristics of the coin-type non-aqueous electrolyte secondary battery obtained in the present Comparative Example were measured just as in Example 1 to thereby acquire charge and discharge curves. The acquired charge and discharge curves are shown in FIG. 1 and FIG. 2.

Then, from the charge and discharge curves acquired in the present Comparative Example, the overvoltage in the charge and discharge time and the energy efficiency were calculated just as in Example 1. The calculated overvoltage in the charge and discharge time and energy efficiency are shown in Table 1.

### EXAMPLE 2

In the present Example, a mixed powder of a cathode active material was obtained just as in Example 1, except for using 0.7 g of an FeF₃ powder (manufactured by Sigma-Aldrich Corp.) and 0.3 g of a Li₄Ti₅O₁₂ powder (manufactured by Sigma-Aldrich Corp.). Then, a mixed powder of a cathode material was obtained just as in Example 1, except for using the mixed powder of the cathode active material obtained in the present Example.

Then, a coin-type non-aqueous electrolyte secondary battery was formed just as in Example 1, except for using the mixed powder of the cathode material obtained in the present Example. Then, the charge and discharge characteristics of the coin-type non-aqueous electrolyte secondary battery obtained in the present Example were measured just as in Example 1 to thereby acquire charge and discharge curves.

Then, from the charge and discharge curves acquired in the present Example, the overvoltage in the charge and discharge time and the energy efficiency were calculated just as in Example 1. The calculated overvoltage in the charge and discharge time and energy efficiency are shown in Table 1.

### EXAMPLE 3

In the present Example, a mixed powder of a cathode active material was obtained just as in Example 1, except for using 0.9 g of an FeF₃ powder (manufactured by Sigma-Aldrich Corp.) and 0.1 g of a Li₄Ti₅O₁₂ powder (manufactured by Sigma-Aldrich Corp.). Then, a mixed powder of a cathode material was obtained just as in Example 1, except for using the mixed powder of the cathode active material obtained in the present Example.

Then, a coin-type non-aqueous electrolyte secondary battery was formed just as in Example 1, except for using the mixed powder of the cathode material obtained in the present Example. Then, the charge and discharge characteristics of the coin-type non-aqueous electrolyte secondary battery obtained in the present Example were measured just as in Example 1 to thereby acquire charge and discharge curves.

Then, from the charge and discharge curves acquired in the present Example, the overvoltage in the charge and discharge time and the energy efficiency were calculated just as in Example 1. The calculated overvoltage in the charge and discharge time and energy efficiency are shown in Table 1.

### EXAMPLE 4

In the present Example, a mixed powder of a cathode material was obtained just as in Example 1, except for mixing 0.4 g of the mixed powder of the cathode active material obtained in Example 1 and 0.071 g of Ketjen black (manufactured by Lion Corp., trade name: Carbon ECP) as a conductive auxiliary.

Then, a coin-type non-aqueous electrolyte secondary battery was formed just as in Example 1, except for using the mixed powder of the cathode material obtained in the present Example. Then, the charge and discharge characteristics of the coin-type non-aqueous electrolyte secondary battery obtained in the present Example were measured just as in Example 1 to thereby acquire charge and discharge curves.

Then, from the charge and discharge curves acquired in the present Example, the overvoltage in the charge and discharge time and the energy efficiency were calculated just as in Example 1. The calculated overvoltage in the charge and discharge time and energy efficiency are shown in Table 1.

### EXAMPLE 5

In the present Example, a mixed powder of a cathode material was obtained just as in Example 4, except for using the mixed powder of the cathode active material obtained in Example 2.

Then, a coin-type non-aqueous electrolyte secondary battery was formed just as in Example 1, except for using the mixed powder of the cathode material obtained in the present Example. Then, the charge and discharge characteristics of the coin-type non-aqueous electrolyte secondary battery obtained in the present Example were measured just as in Example 1 to thereby acquire charge and discharge curves.

Then, from the charge and discharge curves acquired in the present Example, the overvoltage in the charge and discharge time and the energy efficiency were calculated just as in Example 1. The calculated overvoltage in the charge and discharge time and energy efficiency are shown in Table 1.

### EXAMPLE 6

In the present Example, a mixed powder of a cathode material was obtained just as in Example 4, except for using the mixed powder of the cathode active material obtained in Example 3.

Then, a coin-type non-aqueous electrolyte secondary battery was formed just as in Example 1, except for using the mixed powder of the cathode material obtained in the present Example. Then, the charge and discharge characteristics of the coin-type non-aqueous electrolyte secondary battery obtained in the present Example were measured just as in Example 1 to thereby acquire charge and discharge curves.

Then, from the charge and discharge curves acquired in the present Example, the overvoltage in the charge and discharge time and the energy efficiency were calculated just as in Example 1. The calculated overvoltage in the charge and discharge time and energy efficiency are shown in Table 1.

### EXAMPLE 7

In the present Example, a mixed powder of a cathode active material was obtained just as in Example 1, except for first using 0.4 g of an FeF₃ powder (manufactured by Sigma-Aldrich Corp.), 0.3 g of a Li₄Ti₅O₁₂ powder (manufactured by Sigma-Aldrich Corp.) and 0.3 g of a LiFePO₄ powder (manufactured by Sigma-Aldrich Corp.).

Then, a mixed powder of a cathode material was obtained just as in Example 1, except for mixing 0.5 g of the mixed powder of the cathode active material obtained in the present Example and 0.5 g of Ketjen black (manufactured by Lion Corp., trade name: Carbon ECP) as a conductive auxiliary.

Then, a coin-type non-aqueous electrolyte secondary battery was formed just as in Example 1, except for using the mixed powder of the cathode material obtained in the present Example. Then, the charge and discharge characteristics of the coin-type non-aqueous electrolyte secondary battery obtained in the present Example were measured just as in Example 1 to thereby acquire charge and discharge curves. The acquired charge and discharge curves are shown in FIG. 2.

Then, from the charge and discharge curves acquired in the present Example, the overvoltage in the charge and discharge time and the energy efficiency were calculated just as in Example 1. The calculated overvoltage in the charge and discharge time and energy efficiency are shown in Table 1.

TABLE 1

| | | | | Cathode Material (g) | | | |
|---|---|---|---|---|---|---|---|
| | | | | Cathode | | | Energy |
| | Cathode Active Material (g) | | | Active | Conductive | Overvoltage | Efficiency |
| | FeF₃ | Li₄Ti₅O₁₂ | LiFePO₄ | Material | Auxiliary | (V) | (% ) |
| Example 1 | 0.5 | 0.5 | — | 0.3 | 0.3 | 0.52 | 81.7 |
| Example 2 | 0.7 | 0.3 | — | 0.3 | 0.3 | 0.69 | 77.3 |
| Example 3 | 0.9 | 0.1 | — | 0.3 | 0.3 | 0.76 | 75.8 |
| Example 4 | 0.5 | 0.5 | — | 0.4 | 0.071 | 0.64 | 78.3 |
| Example 5 | 0.7 | 0.3 | — | 0.4 | 0.071 | 0.74 | 76.3 |
| Example 6 | 0.9 | 0.1 | — | 0.4 | 0.071 | 0.83 | 73.9 |
| Example 7 | 0.4 | 0.3 | 0.3 | 0.5 | 0.5 | 0.49 | 83.3 |
| Comparative | 0.5 | — | — | 0.5 | 0.5 | 0.99 | 69.7 |
| Example | | | | | | | |

From FIGS. 1 and 2 and Table 1, it is clear that according to the coin-type non-aqueous electrolyte secondary batteries of Example 1 to Example 7 using the cathode materials according to the present invention for their cathodes, the overvoltage in the charge time was low and the energy efficiency was high, as compared with the coin-type non-aqueous electrolyte secondary battery of Comparative Example using a cathode material whose cathode active material was composed only of FeF₃ for its cathode. Therefore, it is clear that according to the cathode material according to the present invention, when the cathode material is used for a cathode of a non-aqueous electrolyte secondary battery, the overvoltage in the charge and discharge time can be reduced and an excellent energy efficiency can be attained.

What is claimed is:

1. A cathode material to be used for a cathode of a secondary battery containing a non-aqueous electrolyte, the cathode material comprising:
FeF₃ and Li₄Ti₅O₁₂ as cathode active materials.

2. The cathode material according to claim 1, wherein the FeF₃ and the Li₄Ti₅O₁₂ as the cathode active materials are in a mass ratio in a range of FeF₃:Li₄Ti₅O₁₂=50:50 to 90:10.

3. The cathode material according to claim 1, further comprising a conductive auxiliary.

4. The cathode material according to claim 3, wherein the cathode active material and the conductive auxiliary is in a mass ratio in a range of the cathode active material:the conductive auxiliary=50:50 to 90:10.

5. The cathode material according to claim 3, wherein the conductive auxiliary is at least one carbonaceous material selected from a group consisting of Ketjen black, carbon black, carbon fibers and carbon nanotubes.

6. The cathode material according to claim 1, further comprising LiFePO₄ as the cathode active material.
